(19) United States
(12) Patent Application Publication
(10) Pub. No.: US 2011/0139035 A1
(43) Pub. Date: Jun. 16, 2011

(54) Aqueous Dispersions of Hydrophobic Silicic Acids

(75) Inventor: Torsten Gottschalk-Gaudig, Mehring (DE)

(73) Assignee: Wacker Chemie AG, Munich (DE)

(21) Appl. No.: 13/060,176

(22) PCT Filed: Aug. 13, 2009
(86) PCT No.: PCT/EP09/60497

§ 371 Date: Feb. 22, 2011

(30) Foreign Application Priority Data
Aug. 22, 2008 (DE) 10 2008 041 466.2

(51) Int. Cl. C09D 1/00; C09K 3/00

(52) U.S. Cl. 106/287.34; 516/53

(57) ABSTRACT

Method for the production of aqueous dispersions of hydrophobic silicic acids wherein the hydrophobic silicic acids are dispersed in an aqueous phase at a pH-value of 0 to 6 and in a subsequent step, the pH-value of the silicic acid dispersion is adjusted to a pH-value of 7-12 through the addition of a base.

### CROSS REFERENCE TO RELATED APPLICATIONS

This application is the national phase filing of international patent application No. PCT/EP2009/060497, filed 13 Aug. 2009, and claims priority of German patent application number 10 2008 041 466.2, filed 22 Aug. 2008, the entirety of which applications are incorporated herein by reference.

### FIELD OF THE INVENTION

The invention relates to aqueous dispersions of hydrophobic silicas, to a process for preparing them, to their use for stabilizing emulsions, and to the use thereof.

### BACKGROUND OF THE INVENTION

Aqueous dispersions of silicas find use in the chemo-mechanical planarizing of metal surfaces, in the semiconductor sector, for example, for coating papers such as ink-jet papers, for example, as rheological additive and/or antisedimentation agent in water-based inks, paints, adhesives, and sealants, in the production of latex products such as gloves, in the production of gel batteries, and in the stabilizing of emulsifier-free Pickering emulsions.

The flow properties and the colloidal stability of aqueous silica dispersions are critically influenced by the pH.

Thus aqueous dispersions of silicas particularly at pH levels in the neutral range exhibit high viscosities and an inherent colloidal instability.

Aqueous silica dispersions are commonly stabilized electrostatically by alteration to the surface charge of the silica particles.

Hence it is known from the specification DE 40 06 392 that colloidally stable and low-viscosity dispersion of hydrophilic silicas can be obtained through the setting of a pH in the basic range.

A disadvantage here is that at pH levels in the region of the neutral point, i.e., at a pH of around 7, as required for numerous applications, said dispersions exhibit an uncontrolled increase in viscosity or even gelling, as shown for example in D. Heath, T. F. Tadros, J. Colloid Interface Sci. 1983, 93, 320. A further lowering of the pH beyond the neutral point then leads to a further fall in the viscosity. This behavior on the part of aqueous dispersions of hydrophilic silicas has the disadvantage that even small changes in the pH, of the kind that may occur, for example, during the formulating of complex mixtures, can lead to uncontrollable fluctuations in the flow properties of the formulation.

It is known, furthermore, from the specification EP 1 124 693 A1, EP 736489 and DE 102 38 463 A1 that aqueous silica dispersions can be stabilized using aluminum salts and, from U.S. Pat. No. 2,892,797, by aluminates. A disadvantage here is that in the region of the neutral point, i.e., at a pH of 7, these dispersions tend toward instability, which can lead to an uncontrolled increase in the viscosity or even to gelling. Furthermore, the addition of aluminum salts may have adverse consequences in certain applications, for example, such as in the coating of ink-jet papers and in the rheology control of water-based epoxy resins, for example.

A disadvantage is the use of hydrophilic silicas for the rheology control of aqueous systems, moreover, as a result of the pronounced tendency of hydrophilic silicas toward irreversible adsorption of oligomers or polymers, such as, for example, binders typically used in water-based coatings, sealants, and adhesives. This results in a difficult-to-control change in the wetting properties of the silica articles, and in inadequate storage stability as a result of polymer bridging or steric stabilization.

DE 102005012409 discloses the preparation of aqueous dispersions of partially hydrophobic silicas, i.e., of silicas having a silanol group density of 0.9 to 1.7 silanol groups/nm², a carbon content of 0.1% to 2%, and a methanol number of less than 30. It has emerged that these dispersions include a significant fraction of inadequately dispersed particles. In applications such as coatings or sealants, for example, these particles may result in a disruption to the surface and hence in a poor optical appearance.

EP 0367934B1 discloses an aqueous dispersion of hydrophobic silica. At industrially relevant silica fill levels of more than 10%, however, this dispersion exhibits high viscosity and formation of paste, and is unsuitable for industrial use.

The preparation of aqueous dispersions of hydrophobic silicas with addition of organic solvents, emulsifiers, wetting agents or protective colloids is likewise known, for example, from DE 10316661. A disadvantage in that case is that these additives frequently detract from the wetting properties on solid substrates and/or detract from the stability of formulations.

### SUMMARY OF THE INVENTION

It is an object of the invention to overcome the disadvantages of the prior art, and particularly to provide for stable dispersion of hydrophobic silicas in a water phase, with high solids contents.

The invention provides a process for preparing aqueous dispersions of hydrophobic silicas, which comprises dispersing the hydrophobic silicas into a water phase at a pH of 0 to 6 and, in a further step, adjusting the pH of the silica dispersion to a pH of 7-12 by addition of base.

### DETAILED DESCRIPTION OF THE INVENTION

Surprisingly, and in no way foreseeably for the skilled worker, it has now been found that, as a result of dispersion, the hydrophobic silicas are dispersed into a water phase at a pH of 0 to 6, and, in a further step, the pH of the silica dispersion is adjusted to a pH of 7-12 by adding base, and dispersions of hydrophobic silica are obtained that have high solids contents and a narrow breadth of distribution of the hydrodynamic equivalent diameter of the silica aggregates, and these dispersions in the pH range of 7-12 exhibit excellent colloidal stability even after long storage and in the pH range of 5-8 exhibit no local or absolute viscosity maximum, i.e., display a continual increase in viscosity.

Colloidally stable means that during the 4-week storage the dispersions do not exhibit any marked increase in viscosity and that the average particle diameter, measured by means of dynamic light scattering, remains constant. Colloidal stability is a prerequisite for appropriate storage properties. Aqueous dispersions which, in the course of storage, display an uncontrolled increase in viscosity, or even gelling, are frequently no longer suitable for further processing, since high viscosities impact adversely on processing operations such as pump conveying or stirring.

A continual increase in viscosity with falling pH is of advantage over the fluctuating pH dependence known from the prior art, since if a defined pH is set, regions of unwanted and partially uncontrollable high viscosity and hence more difficult manageability do not occur.

Hydrophobic silica in this context means apolar fumed silicas which are modified on the surface, preferably silylated, of the kind described, for example, in the laid-open specifications EP 686676 B1 or EP 1433 749 A1.

For the silicas used in accordance with the invention this means that the surface of the silica is hydrophobicized, i.e., silylated.

The hydrophobic silicas used in accordance with the invention have a silanol group density of preferably less than 1.8 silanol groups per nm², more preferably of less than 1.0 silanol groups per nm², and very preferably of less than 0.9 silanol groups per nm².

The hydrophobic silicas used in accordance with the invention have a carbon content of preferably greater than or equal to 0.4% by weight of carbon, more preferably 0.5% by weight to 10% by weight of carbon, and very preferably 0.75% by weight to 5% by weight of carbon, the weight being based on the hydrophobic silica.

The hydrophobic silicas used in accordance with the invention have a methanol number of preferably greater than 0, more preferably greater than 20, and very preferably greater than 40.

The hydrophobic silicas used in accordance with the invention preferably have a DBP number (dibutyl phthalate number) of less than 250, more preferably of 250 to 150.

The silanol group density is obtainable by means of acid-based titration, as given in G. W. Sears, Anal. Chem. 1956, 28, 1981; the carbon content can be determined by means of elemental analysis; and the methanol number is the percentage fraction of methanol which must be added to the water phase in order to achieve complete wetting of the silica, i.e., complete sunken incorporation of the silica in the test liquid.

In a preferred process for preparing the dispersions of the invention, the hydrophobic silicas are added to the water phase, preferably at a pH of 0 to 7, preferably at a pH of 0.5 to 5, and more preferably at a pH of 1 to 3, and are preferably incorporated by spontaneous wetting or by forced wetting such as, for example, by shaking, such as, for example, with a tumble mixer, or by stirring, such as, for example, by means of cross-arm stirrers, dissolvers, rotor-stator systems or inductors with compulsory wetting in the shear slot. In this context it is proven advantageous to monitor the pH, preferably during the addition of the hydrophobic silica, during incorporation, and during subsequent dispersing, at regular intervals, and, in the event of any deviation, to correct it to the desired, target level by adding acid or base. Adjusting or correcting the pH level can be done using commercially customary organic and inorganic acids, i.e., Brönsted acids such as preferably aqueous or gaseous HCl, aqueous or anhydrous HNO₃, H₂SO₄, H₃PO₄, p-toluenesulfonic acid, citric acid, preferably inorganic acids such as aqueous or gaseous HCl, aqueous or anhydrous HNO₃, H₂SO₄, H₃PO₄, more preferably H₃PO₄ or Brönsted bases, such as, preferably, aqueous or gaseous ammonia, aqueous or anhydrous NaOH, KOH, CaCO₃, CaO, Na methoxide or organic amines, preferably aqueous or gaseous ammonia, aqueous or anhydrous NaOH, KOH.

After the desired silica concentration has been achieved, and after subsequent dispersing, where necessary, the pH of the silica dispersion is preferably adjusted to the inventive range of 5-12 by addition of base. The pH adjustment takes place preferably under low shear, i.e., using mixing assemblies with a low shearing effect, such as slow-running dissolvers, cross-arm stirrers, paddle stirrers, static mixers, and others, with a peripheral speed of not more than 2.5 m/s, preferably with a peripheral speed of not more than 2 m/s, and more preferably with a peripheral speed of not more than 1 m/s. The silica concentration in the acidic dispersion is preferably greater than 10% by weight, more preferably 10% by weight to 60% by weight, very preferably 15% by weight to 55% by weight, with very particular preference 20% by weight to 50% by weight, and, in one special embodiment, 20% by weight to 30% by weight, based on the total weight of the dispersion.

Adjusting or correcting the pH level can be done using commercially customary organic and inorganic acids, i.e., Brönsted acids such as preferably aqueous or gaseous HCl, aqueous or anhydrous HNO₃, H₂SO₄, H₃PO₄, p-toluenesulfonic acid, citric acid, preferably inorganic acids such as aqueous or gaseous HCl, aqueous or anhydrous HNO₃, H₂SO₄, H₃PO₄, more preferably H₃PO₄ or Brönsted bases, such as, preferably, aqueous or gaseous ammonia, aqueous or anhydrous NaOH, KOH, CaCO₃, CaO, Na methoxide or organic amines preferably aqueous or gaseous ammonia, aqueous or anhydrous NaOH, KOH.

In the case of low particle concentrations, below 10% by weight, simple stirring is generally sufficient to incorporate the particles into the liquid. Preference is given to incorporating the particles into the liquid at a high shear rate.

Prior to its incorporation the hydrophobic silica may be in a packaged form, such as in bags, or in storage in a loose form, such as in silos or large-scale containers, for example. The hydrophobic silicas can be metered in via bag shaking, via metering silos with or without weighing, or by direct conveying from storage silos or large-scale containers by means of suitable conveying equipment such as compressed-air membrane pumps or fans.

After or in parallel with the incorporation, the particles are dispersed. Parallel dispersing is preferred. Parallel dispersing means that the start of the metered addition and incorporation of the silica into the aqueous phase is accompanied by the start of the dispersing operation. This can be done by means of a dispersing system in the vessel, or by pumped circulation in external pipelines, containing a dispersing member, from the vessel, with preferably closed-loop recycling back to the vessel. By means of a partial recycle and partial continuous withdrawal, this operation can preferably be made continuous. Apparatus suitable for these purposes includes, preferably, high-speed stirrers, high-speed dissolvers, with peripheral speeds of 1-50 m/s, for example, high-speed rotor-stator systems, sonolators, shearing gaps, nozzles or ballmills.

The incorporating and dispersing of the silica can take place preferably by means of inductors, such as Conti TDS 4 from Ystral, for example. In that case the pulverulent, hydrophobic silica is metered directly into the shearing gap by suction, by vacuum or by forced conveying, by means of pumps, for example.

Particularly appropriate for dispersing the hydrophobic silicas is the use of ultrasound, preferably in the range from 5 Hz to 500 kHz, preferably 10 kHz to 100 kHz, with very particular preference 15 kHz to 50 kHz; the ultrasonic dispersing can take place continuously or discontinuously. It can be done by individual ultrasonic transducers, such as ultrasound tips, or in continuous-flow systems, containing one or more ultrasonic transducers, systems separated if desired by a pipeline or pipe wall.

Dispersing may if appropriate take place through a combination of different methods: for example, preliminary dispersing by means of dissolvers or inductors, with subsequent fine dispersing by means of ultrasound treatment.

The dispersing takes place preferably at elevated temperature, in a temperature range of preferably 30° C. to 90° C., more preferably in a temperature range of 35° C. to 80° C., very preferably in a temperature range of 40° C. to 75° C., and, in one special embodiment, in a temperature range from 40° C. to 60° C.

The heat treatment takes place preferably by means of the heat developed during the dispersing operation and/or by means of external heat sources, such as electrical heating using heating jackets, steam heating via heating coils or the like. Where appropriate, cooling may be carried out additionally, for the purpose of regulating the temperature, by means, for example, of cooling jackets or cooling coils filled with a coolant medium.

The preparation of the invention may take place in batch processes and in continuous processes. Continuous processes are preferred.

The fine dispersion is carried out preferably on a highly concentrated masterbatch dispersion, and then diluted down to the desired final concentration. The masterbatch dispersion preferably contains more than 20% by weight of hydrophobic silica, more preferably 20% to 60% by weight of hydrophobic silica, and very preferably 25% to 55% by weight of hydrophobic silica, and, with very particular preference, 25% to 50% by weight of hydrophobic silica, based on the total weight of the dispersion.

In one particularly preferred procedure, the masterbatch is pre-diluted with DI water (fully deionized water=DI water) prior to pH inversion from acidic to basic, and, after this preliminary dilution, the pH is adjusted and, in a final step, the desired solids content is set by addition of DI water.

To prepare the dispersions of the invention it is preferred to use pure water, preferably fully deionized (DI) water having a conductivity of less than 100 μS/cm.

The conductivity of the dispersions of the invention is preferably less than 20 mS/cm, more preferably less than 15 mS/cm, very preferably less than 10 ms/cm.

The processes of the invention have the advantage that they are very simple to implement and enable the preparation of aqueous dispersions having very high hydrophobic silica solids contents.

The dispersions of the invention preferably have a hydrophobic silicas content of more than 10% by weight, more preferably 10% by weight to 60% by weight, with particular preference 15% by weight to 55% by weight, with very particular preference 20% by weight to 50% by weight and in one specific embodiment 20% by weight to 30% by weight based on the total weight of the dispersion.

The aqueous dispersions of the invention having a high hydrophobic silicas content are particularly characterized in that they preferably have a pH in the range from 7 to 12, preferably 7.5 to 11, with particular preference 8 to 10.5.

The aqueous dispersions of hydrophobic silicas of the invention are characterized in particular in that they have a narrow size distribution of the hydrodynamic equivalent diameter. This means that the polydispersity index (PDI) in the particle size determination by means of photon correlation spectroscopy is preferably less than 0.5, more preferably less than 0.4, and very preferably less than 0.3, and, in one special embodiment, less than 0.25.

The aqueous dispersions of hydrophobic silicas of the invention are characterized in particular in that they have at maximum a bimodality of the size distribution of the hydrodynamic equivalent diameter, i.e., the size distribution has a maximum of two isolated monomodal distributions. The maximum value or else modal value of the first monomodal distribution is preferably in the range from 0 to 500 nm, and the maximum value or else modal value of the second monomodal distribution is in the range of preferably 500 to 5000 nm. The intensity of the second monomodal distribution in the range from 500 to 5000 nm is preferably not more than 50% of the total intensity of both distributions, more preferably not more than 25% of the total intensity of both distributions, with particular preference not more than 10% of the total intensity of both distributions, and, in one special embodiment, there is no detectable second monomodal distribution in the range from 500 to 5000 nm, i.e., the overall distribution is monomodal.

The aqueous dispersions of the invention having a high hydrophobic silicas content are characterized in particular in that low-viscosity dispersions are obtainable with a pH in the range from 7 to 12, preferably 7.5 to 11, with particular preference 8 to 10.5. This means that the dispersions preferably having a pH in the range from 8 to 10.5 and a silicas content of 20% to 30% by weight have a viscosity of less than 1000 mPas, preferably a viscosity of less than 800 mPas, with particular preference a viscosity of less than 700 mPas, and very particular preference a viscosity of less than 500 mPas, the viscosity being measured using a cone-plate sensor system with a 105 μm measuring gap, at 25° C. and a shear rate of 100 s⁻¹.

The aqueous dispersions of the invention having a high hydrophobic silicas content are further characterized in that a graduated or continuous reduction in the dispersion pH from 9 to 4 is accompanied by a gradual continuous increase in the viscosity, but without the occurrence of a local viscosity maximum of any significance—that is, one going beyond the typical experimental scatter. This means in particular that, preferably, the ratio η_{7/9}=η₇/η₉, formed from the shear viscosity at a pH of 9 (η₉) and at a pH of 7 (η₇), and the ratio η_{4/7}=η₄/η₇, formed from the shear viscosity at a pH of 7 (η₇) and at a pH of 4 (η₄), each have a value of greater than or equal to 1, preferably a value of 1 to 1000, more preferably a value of 1 to 500, and very preferably a value of 1 to 100, the viscosity being measured with a cone-plate sensor system with a 105 μm measuring gap, at 25° C. and a shear rate of 100 s⁻¹.

The aqueous dispersions of the invention having a high hydrophobic silicas content are further characterized in that they exhibit an excellent storage stability.

This means that the viscosity of a dispersion preferably having a pH in the range from 8-10.5 after a storage time of 4 weeks at 40° C. has risen by not more than a factor of 5, preferably by not more than a factor 2.5, more preferably by not more than a factor of 2.0, and very preferably by not more than a factor of 1.5, as compared with the viscosity immediately after preparation of the dispersion, the viscosity being measured using a cone-plate sensor system with a 105 μm measuring gap, at 25° C. and a shear rate of 100 s⁻¹.

The aqueous dispersions of the invention having a high hydrophobic silicas content are further characterized in that they exhibit an excellent storage stability.

This means that the dispersions preferably having a pH in the range from 8-10.5, after a storage time of 4 weeks at 40° C. have a yield point of less than 100 Pa, preferably less than 10 Pa, more preferably less than 1 Pa, and very preferably less than 0.1 Pa, measured in each case using the vane method at 25° C. in accordance with Q. D. Nguyen, D. Boger, J. Rheol. 1985, 29, 335.

The dispersions of the invention are further characterized in that preferably in the pH range of 7-12 they exhibit a negative ZETA potential. Preferably the ZETA potential at pH of 9 is less than −5 mv, more preferably less than −10 mv, and very preferably less than −15 mV. The ZETA potential can be determined, for example, by measuring the colloid vibration potential, using, for example, the ZETA potential probe DT300 from Dispersion Technologies, or by determining the electrophoretic mobility by laser Doppler velocimetry using the Zetasizer ZS from Malvern Instruments.

The dispersions of the invention are further characterized in that they preferably have an isoelectric point (iep) at a pH of more than 4, the isoelectric point being defined as the pH of a dispersion for which the ZETA potential has the value zero.

The dispersions of the invention are further characterized in that the dispersed particles are preferably in the form of finely divided sinter aggregates.

The sinter aggregates are characterized in that, in the case of particle size determination by means of quasielastic light scattering, the measured hydro-dynamic equivalent diameter is preferably greater by a factor of at least 2, preferably by a factor of 2.5 to 50, more preferably by a factor 2.8 to 30, based in each case on a specific surface area of 100 m²/g—in the case of a smaller or larger surface area, the factor decreases or increases linearly in accordance—than the diameter of the primary particles which is obtainable arithmetically in accordance with the formula a=6/A_{BET}*d, where A_{BET} is the specific BET surface area of the initial hydrophilic silica, as measured by means of nitrogen adsorption in accordance with DIN 66131, and d is the density of the primary particles.

The dispersions of the invention are further characterized in that if desired they comprise fungicides or bactericides, such as methylisothiazolones or benziso-thiazolones.

The amount of further organic adjuvants, such as, preferably, organic solvents, other than fungicides or bactericides in the aqueous dispersion of the invention is preferably less than 5%, more preferably less than 1%, very preferably less than 0.5%, and in particular less than 0.1% by weight, based on the total weight of the dispersion, and in one specific embodiment, no further organic adjuvants, such as organic solvents, other than fungicides or bactericides, are added.

In particular, the amount of organic or inorganic dispersing assistants such as, preferably, surfactants, protective colloids or other finely divided metal oxides having identical or different surface loading, such as the hydrophobic silicas, i.e., having identical or different ZETA potential, such as the hydrophobic silicas in the aqueous dispersions of the invention is preferably less than 5%, preferably less than 1%, more preferably less than 0.5% by weight, based on the total weight of the dispersion, and in particular the aqueous dispersions of the invention contain no organic or inorganic dispersing assistants.

The hydrophobic silica particles preferably have an average primary particle size d-PP of 0.5 to 1000 nm, more preferably 5 to 100 nm, very preferably 5 to 50 nm. Suitable methods of measuring this are, for example, transmission electron microscopy or high-resolution scanning electron microscopy, in the field emission mode, for example.

The hydrophobic silica particles preferably have an average secondary structure particle size or aggregate particle size d-Aggr of 25 to 5000 nm, more preferably of 50 to 800 nm, very preferably of 75 to 500 nm, measured as the hydrodynamic equivalent diameter.

Suitable methods of measuring this are, for example, dynamic light scattering or photon correlation spectroscopy, performed in backscattering for the purpose of measuring concentrations of less than 0.01% by weight, and/or corrected by means of cross-correlation against multiple scattering.

The invention further provides the preparation of particle-stabilized O/W emulsions (Pickering emulsions) using the dispersions of the invention.

In this context it has been found that the best results are given by the process described in the text below.

A dispersion of the invention with a low viscosity at a pH of preferably 9 is preferably acidified preferably to a pH of less than 5 by addition of a protic acid, hydrochloric acid for example. The oil phase is then preferably incorporated by emulsification into the silica dispersion, which now has a higher viscosity, emulsification preferably taking place by means for example of a high-speed mixing apparatus such as dissolvers, rotor-stator systems, or in ultrasonicators or other emulsifying machines. If desired, water can be metered in additionally after the total amount of oil has been incorporated. This can be done under shearing conditions or by means of simple stirring.

If desired, it is also possible first to introduce the oil phase and then to incorporate the dispersion of the invention by dispersing with stirring, preferably by means for example of high-speed mixing apparatus such as, preferably, dissolvers, rotor-stator systems, or in ultrasonicators.

If desired, the resulting emulsions can again be subjected to a further emulsifying operation for the purpose of improving their properties, such an operation preferably taking place, for example, in high-pressure homogenizers or continuous-flow ultrasound cells.

If desired, the pH of the emulsion obtained can preferably be adjusted to the desired level by addition of acid, hydrochloric acid for example, or base, aqueous NaOH solution for example. This can preferably be done with simple stirring or under shearing conditions, in a dissolver, for example. Simple stirred incorporation is preferred.

If desired, the ionic strength of the aqueous phase of the emulsion can be adjusted to the desired ionic strength by addition of, preferably, electrolyte, NaCl for example, in order to increase the viscosity of the emulsion. This can preferably be done with simple stirring or under shearing conditions, in a dissolver, for example. Simple stirred incorporation is preferred.

For the purpose of increasing the viscosity it is possible to add preferably 1·10⁻⁴ mol/l to 10 mol/l, more preferably 0.5 ·10⁻³ mol/l to 5 mol/l, and more preferably 1 ·10⁻³ mol/l to 1 mol/l of electrolyte to the emulsion.

The invention further relates to the use of the aqueous dispersions of the invention, preferably in the coating of surfaces, such as mineral substrates, such as metals, steel or iron for example, with the aim for example of corrosion control.

The invention further relates to the use of the aqueous dispersions of the invention, preferably in the preparation of inks and paints, synthetic resins, adhesives, and sealants, especially those produced on an aqueous basis.

The invention relates to the use of the aqueous dispersions of the invention in the preparation of, preferably inks and paints, synthetic resins, adhesives, and sealants, in particular for the purpose of adjusting and controlling the rheology.

The invention relates to the use of the aqueous dispersions of the invention in the preparation of, preferably inks and paints, synthetic resins, adhesives, and sealants, in particular for the purpose of improving their mechanical properties, such as improving the scratch resistance, for example, and improving the flow properties in preparations for use on surfaces.

The invention further provides surface coatings comprising the dispersions of the invention.

The invention relates to the use of the aqueous dispersions of the invention in the coating of print media, particularly of those papers which are used in contactless printing processes; examples are papers for inkjet printers and, in particular, high-gloss papers.

All of the above symbols in the above formulae have their definitions in each case independently of one another. In all formulae the silicon atom is tetravalent.

For the purposes of the present invention, unless indicated otherwise in each case, all quantity and percentage figures are by weight, and all percentage figures are based on the total weight; all temperatures are 20° C. and all pressures are 1.013 bar (abs.). All viscosities are determined at 25° C.

The invention relates preferably to the use of the aqueous dispersions of the invention in chemo-mechanical planarization of surfaces in the semiconductor sector.

### EXAMPLES

### Example 1

300 g of a hydrophobic fumed silica (available under the name HDK® H20 from Wacker Chemie AG, Munich) having a residual silanol content of 50% and a carbon content of 1.3%, obtained by treating a hydrophilic starting silica having a specific BET surface area of 200 m²/g with dimethyldichlorosilane, are incorporated by dispersing, in portions, on a dissolver at 5000-8000 rpm into 450 g of fully deionized DI water. The pH of the dispersion is maintained within a range of 2-2.5 by metered addition of aqueous H₃PO₄. Following complete addition of the silica, dispersing is continued at 8000 rpm and at a temperature from 45 to 50° C. for 30 minutes. The low-viscosity dispersion obtained is subsequently diluted with 550 g of DI water while stirring slowly and the pH is brought to pH 9 with aqueous NaOH. The result is a highly mobile silica dispersion, whose analytical data are summarized in table 1.

### Example 2

300 g of a hydrophobic fumed silica (available under the name HDK® H30 from Wacker Chemie AG, Munich) having a residual silanol content of 50% and a carbon content of 1.9%, obtained by treating a hydrophilic starting silica having a specific BET surface area of 300 m²/g with dimethyldichlorosilane, are incorporated by dispersion, in portions, on a dissolver at 5000-8000 rpm into 450 g of fully deionized DI water. The pH of the dispersion is maintained within a range of 2-2.5 by metered addition of aqueous H₃PO₄. Following complete addition of the silica, dispersing is continued at 8000 rpm and at a temperature from 45 to 50° C. for 30 minutes. The low-viscosity dispersion obtained is subsequently diluted with 550 g of DI water while stirring slowly and the pH is brought to pH 9 with aqueous NaOH. The result is a highly mobile silica dispersion, whose analytical data are summarized in table 1.

### Example 3

300 g of a hydrophobic fumed silica having a residual silanol content of 72% and a carbon content of 0.6%, obtained by reacting a hydrophilic starting silica having a specific BET surface area of 200 m²/g (available under the name HDK® N20 from Wacker Chemie AG, Munich) with dimethyldichlorosilane in accordance with EP 1433749 A1, are incorporated by dispersing, in portions, on a dissolver at 5000-8000 rpm into 450 g of fully deionized DI water. The pH of the dispersion is maintained within a range of 2-2.5 by metered addition of aqueous H₃PO₄. Following complete addition of the silica, dispersing is continued at 8000 rpm and at a temperature from 45 to 50° C. for 30 minutes. The low-viscosity dispersion obtained is subsequently diluted with 550 g of DI water while stirring slowly and the pH is brought to pH 9 with aqueous NaOH. The result is a highly mobile silica dispersion, whose analytical data are summarized in table 1.

### Example 4

750 g of a hydrophobic fumed silica (available under the name HDK® H15 from Wacker Chemie AG, Munich) having a residual silanol content of 50% and a carbon content of 1.0%, obtained by treating a hydrophilic starting silica having a specific BET surface area of 150 m²/g with dimethyldichlorosilane, are incorporated by dispersion, in portions, on a dissolver at 5000-8000 rpm into 1000 g of fully deionized DI water. The pH of the dispersion is maintained within a range of 2-2.5 by metered addition of aqueous H₃PO₄. Following complete addition of the silica, dispersing is continued at 8000 rpm and at a temperature from 45 to 50° C. for 30 minutes. The low-viscosity dispersion obtained is subsequently diluted with 800 g of DI water while stirring slowly and the pH is brought to pH 9 with aqueous NaOH. The result is a highly mobile silica dispersion, whose analytical data are summarized in table 1.

### Example 5

750 g of a hydrophobic fumed silica having a residual silanol content of 72% and a carbon content of 0.60, obtained by reacting a hydrophilic starting silica having a specific BET surface area of 200 m²/g (available under the name HDK® N20 from Wacker Chemie AG, Munich) with dimethyldichlorosilane in accordance with EP 1433749 A1, are incorporated by dispersing, in portions, on a dissolver at 5000-8000 rpm into 1000 g of fully deionized DI water. The pH of the dispersion is maintained within a range of 2-2.5 by metered addition of aqueous H₃PO₄. Following complete addition of the silica, dispersing is continued at 8000 rpm and at a temperature from 45 to 50° C. for 30 minutes. The low-viscosity dispersion obtained is subsequently diluted with 800 g of DI water while stirring slowly and the pH is brought to pH 9 with aqueous NaOH. The result is a highly mobile silica dispersion, whose analytical data are summarized in table 1.

### Example 6

350 g of a hydrophobic fumed silica (available under the name HDK® H20 from Wacker Chemie AG, Munich) having a residual silanol content of 50% and a carbon content of 1.3%, obtained by treating a hydrophilic starting silica having a specific BET surface area of 200 m²/g with dimethyldichlorosilane, are incorporated by dispersion, in portions, on a dissolver at 5000-8000 rpm into 1000 g of fully deionized DI water. The pH of the dispersion is maintained within a range of 2-2.5 by metered addition of aqueous H₃PO₄. Following complete addition of the silica, dispersing is continued at 8000 rpm and at a temperature from 45 to 50° C. for 30 minutes. The low-viscosity dispersion obtained is subsequently diluted with 800 g of DI water while stirring slowly and the pH is brought to pH 9 with aqueous NaOH. The low-viscosity dispersion stabilized at 45° C. is subsequently pumped with a flow rate of 5-10 ml/min through a continuous-flow ultrasound cell (from Hielscher; 24 kHz; 400 W). The result is a highly mobile silica dispersion, whose analytical data are summarized in table 1.

### Example 7

### Not Inventive

300 g of a hydrophobic fumed silica (available under the name HDK® H20 from Wacker Chemie Ag, Munich) and having a residual silanol content of 50% and a carbon content of 1.3%, obtained by treating a hydrophilic starting silica having a specific BET surface area of 200 m²/g with dimethyldichlorosilane, are incorporated by stirring, in portions, on a dissolver 300-600 rpm into 1000 g of fully deionized DI water. The pH of the dispersion is maintained within a range of 9-9.5 by metered addition of aqueous NaOH. Following complete addition of the silica, dispersing is continued at 6000 rpm for 30 minutes, and the suspension is cooled to 20° C. The result is a silica dispersion, whose analytical data are summarized in table 1.

TABLE 1

| | Silica | | Zeta potential | η/Pas | η/Pas | η/Pas | | |
|---|---|---|---|---|---|---|---|---|
| | [%] | pH | [mV]; (pH 9) | (pH 9) | (pH 7) | (pH 4) | PDI | Iᵣₑₗ/% |
| Example 1 | 23.6 | 9.03 | −31.8 | 0.38 | 1.99 | 2.41 | 0.19 | 24 |
| Example 2 | 22.9 | 9.15 | −29.1 | 0.52 | 3.68 | 4.89 | 0.23 | 38 |
| Example 3 | 23.3 | 9.28 | −19.5 | 0.012 | 0.11 | 0.38 | 0.17 | 0 |
| Example 4 | 29.1 | 9.42 | −25.4 | 0.08 | 0.17 | 0.48 | 0.18 | 10 |
| Example 5 | 28.7 | 9.47 | −15.2 | 0.03 | 0.075 | 0.32 | 0.13 | 0 |
| Example 6 | 25.9 | 9.09 | −32.6 | 0.25 | 1.34 | 2.06 | 0.18 | 17 |
| Example 7 | 23.8 | 9.24 | −28.4 | 0.44 | 2.36 | 3.13 | 1.0 | 84 |

Solids content of the dispersion determined by the following method: 10 g of aqueous dispersion are admixed with an equal amount of ethanol in a porcelain dish, and evaporated in an N₂-flushed drying oven at 150° C. to constant weight. The mass mₛ of the dry residue gives the solids content as follows:

solids content/%=mₛ*100/10 g.
ZETA potential of the dispersions measured by the following method: a dispersion is diluted to approximately 1.5% by weight silica using DI water having a pH identical to that of the dispersion. On a Zetasizer ZS from Malvern Instruments, the ZETA potential is measured over the pH range from 9.2 to 2, the pH adjustment being accomplished by means of an autotitrator in pH steps of 1.
Viscosity of the dispersion determined using a RS 600 rheometer from Haake with a cone-plate sensor system (105 μm measuring gap) at 25° C. and a shear rate D=100 s⁻¹.
Average diameter of the sinter aggregates measured by means of photon correlation spectroscopy by the following method: a dispersion is diluted to approximately 0.3% by weight silica using DI water having a pH identical to that of the dispersion. The sample is measured in backscattering at 25° C. on a Zetasizer ZS from Malvern Instruments. The average diameter of the aggregates is the z-average (cumulant average) and corresponds to the hydrodynamic equivalent diameter of the silica aggregates. The relative intensity Iᵣₑₗ of the monomodal distribution in the range from 500 nm to 5000 nm is given by Iᵣₑₗ=I(500-5000)/I(0-500)+I(500-5000), where I(0-500) and I(500-5000) are the absolute signal intensities of the monomodal distributions in the range of 0 nm-500 nm and 500 nm-5000 nm, respectively. The PDI is the polydispersity index, given by the ratio of the second pulse in the cumulant analysis of the autocorrelation function, divided by the average decay constant in the cumulant analysis.
pH measured by means of combination pH electrode

### Example 8

### Preparation of an Emulsion

54 g of the silica dispersion described in example 1 with a solids content of 23% by weight are charged to a 500 ml stainless steel beaker. Aqueous HCl is added to set a pH of approximately 5. The suspension, which is now of higher viscosity, is admixed slowly with 150 g of a polydimethylsiloxane having a viscosity of 100 mPas (available under the name “AK100” from Wacker-Chemie GmbH, Munich (DE)) by metering over a period of about 15 minutes, with stirring at 10 000 rpm using an Ultraturrax and with water cooling. During this addition the temperature of the mixture ought not to rise above 60° C. The resulting firm mass, which is now of high viscosity, is subsequently admixed with 108 g of DI water, likewise at 10 000 rpm and slowly over a period of 15 minutes. During this addition the temperature of the mixture ought not to rise above 60° C. The result is a highly mobile, white O/W emulsion, whose analytical data are summarized in table 2.

TABLE 2

| | d₅₀/μm | pH | η/Pas (pH 5.45) |
|---|---|---|---|
| Example 8 [4] | 5.4 | 5.45 | 0.152 |

average droplet diameter d₅₀, measured by means of Fraunhofer laser diffraction on a Sympatec Helos/BF using cell measurement.
pH measured by means of a combined pH electrode.

Viscosity of the emulsion determined using an RS 600 rheometer from Haake with a cone-plate sensor system (105 μm measuring gap) at 25° C. and a shear rate D=10 s⁻¹.

1. A process for preparing aqueous dispersions of hydrophobic silicas, wherein the hydrophobic silicas are dispersed into a water phase at a pH of 0 to 6 and, in a further step, adjusting the pH of the silica dispersion to a pH of 7-12 by adding base.

2. The process as claimed in claim 1, wherein the dispersing takes place at a temperature from 30° C. to 90° C.

3. The process as claimed in claim 1, wherein the silica concentration in the acidic dispersion is 10% by weight to 60% by weight.

4. The process as claimed in claim 1, wherein the acidic dispersion is diluted before the pH is adjusted to a level of 7 to 12.

5. The process as claimed in claim 1, wherein the adjustment of the pH takes place using minimal shearing forces.

6. An aqueous dispersion of hydrophobic silicas, wherein the dispersion has a pH of 7 to 12 and a polydispersity index of less than 0.5.

7. The aqueous dispersion of hydrophobic silicas as claimed in claim 6, wherein the particle size distribution of the dispersion has not more than two isolated monomodal distributions, the maximum value of the first monomodal distribution lying in the range from 0 to 500 nm and the maximum value of the second monomodal distribution lying in the range from 500 to 5000 nm.

8. A process for preparing particle-stabilized O/W emulsions (Pickering emulsions), wherein dispersions as claimed in claim 6 are used.

9. A process for improving the scratch resistance of surface coatings, wherein dispersions as claimed in claim 6 are used.

10. A process for improving the flow properties for preparations for use on surfaces, wherein dispersions as claimed in claim 6 are used.

11. A process for preparing print media, wherein dispersions as claimed in claim 6 are used.

12. A surface coating, wherein the coating is comprised of a dispersion as claimed in claim 6.

13. A process for preparing particle-stabilized O/W emulsions (Pickering emulsions), wherein dispersions prepared as claimed in claim 1 are used.

14. A process for improving the scratch resistance of surface coatings, wherein dispersions prepared as claimed in claim 1 are used.

15. A process for improving the flow properties for preparations for use on surfaces, wherein dispersions prepared as claimed in claim 1 are used.

16. A process for preparing print media, wherein dispersions prepared as claimed in claim 1 are used.

17. A surface coating, wherein the coating is comprised of a dispersion prepared as claimed in claim 1.
